(19) United States
(12) Patent Application Publication
(10) Pub. No.: US 2025/0299080 A1
(43) Pub. Date: Sep. 25, 2025

(54) QUANTUM COMPUTER AND QUANTUM COMPUTING SYSTEM

(71) Applicant: Hitachi, Ltd., Tokyo (JP)

(72) Inventor: Saki SUSA, Tokyo (JP)

(21) Appl. No.: 18/863,363

(22) PCT Filed: May 30, 2022
(86) PCT No.: PCT/JP2022/021969

§ 371 Date: Nov. 6, 2024

(51) Int. Cl. G06N 10/40; G06N 10/20

(52) U.S. Cl. CPC G06N 10/40; G06N 10/20

(57) ABSTRACT

A quantum computer has a qubit control section that controls a qubit array in which a plurality of qubits are disposed in a two-dimensional square lattice manner and a shared control line capable of controlling a plurality of qubit pairs composed of a pair of qubits adjacent. The qubit control section controls part of the qubit pairs among the plurality of qubit pairs by a plurality of two-qubit gates that are given a constraint condition relating to a product of operations and that execute operation processing on a plurality of qubit pairs.

### TECHNICAL FIELD

The present invention relates to a quantum computer and a quantum computing system.

### BACKGROUND ART

A large quantity of qubits are necessary for implementation of a fault tolerant quantum computer. A control line that changes the gate voltage is required for control of the qubits on a circuit.

With chip design in which the control line is disposed for each of all qubits, the number of qubits that can be made is limited due to the number of control lines when the scale is increased. For a solution to this problem of the scalability due to the number of control lines, there arises a need to simultaneously control a plurality of qubits by one control line as in Patent Document 1.

In an apparatus of Patent Document 1, qubits are disposed in an array manner and are given control lines common in units of column or row, and exchange interaction between two qubits is controlled by this control line and a two-qubit gate is obtained. Because the control lines are shared, the two-qubit gate is implemented for all qubit pairs in the same column or the same row, and this two-qubit gate on the plurality of qubits serves as the basic gate.

### PRIOR ART DOCUMENT

### Patent Document

Patent Document 1: JP-2021-027142-A

### SUMMARY OF THE INVENTION

### Problem to be Solved by the Invention

In a silicon quantum dot array, when the gate voltage is changed or a DC magnetic field is applied in order to execute gate operation of a target qubit, an undesirable influence (rotation of a phase or decoherence) is caused also on the qubit other than the target qubit.

In Patent Document 1, the above-described problem is solved in terms of hardware by contrivance of a configuration of the apparatus.

An object of the present invention is to execute gate operation of a target qubit in terms of software in a quantum computer.

### Means for Solving the Problem

A quantum computer according to one aspect of the present invention includes a qubit array in which a plurality of qubits are disposed in a two-dimensional square lattice manner, a qubit control section that controls the qubit array, and a shared control line capable of controlling a plurality of qubit pairs composed of a pair of the qubits adjacent, in which the qubit control section controls part of the qubit pairs among the plurality of qubit pairs by a plurality of two-qubit gates that are given a constraint condition relating to a product of operations and that execute operation processing on a plurality of the qubit pairs, and does not control the qubit pairs other than the part of the qubit pairs.

Moreover, the quantum computer according to the one aspect of the present invention has the following feature. Interaction operated by the shared control line is exchange interaction or XY interaction. The quantum computer is configured by a system in which operation on a plurality of the qubit pairs as a basic gate is a PSWAP gate or an (iSWAP)^{α} gate. The PSWAP gate is a gate given as a power of a SWAP gate (formula 1-1) and satisfies (formula 1-2). A matrix representation of the PSWAP gate is given by (formula 1-3), and a matrix representation of the (iSWAP)^{α} gate is given by (formula 1-4), and a rotation angle α takes a real value of 0 to 2.

$$[ Formula 1 - 1 ]$$

$$PSWAP ( α ) = {( SWAP )}^{α} \qquad ( formula 1 - 1 )$$

$$[ Formula 1 - 2 ]$$

$$PSWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] \qquad ( formula 1 - 2 )$$

$$[ Formula 1 - 3 ]$$

$$PSWAP ( α ) = [ \begin{matrix}1 & 0 & 0 & 0 \\ 0 & \frac{1 + {e}^{- i απ}}{2} & \frac{1 - {e}^{- i απ}}{2} & 0 \\ 0 & \frac{1 - {e}^{- i απ}}{2} & \frac{1 + {e}^{- i απ}}{2} & 0 \\ 0 & 0 & 0 & 1\end{matrix} ] \qquad ( formula 1 - 3 )$$

$$[ Formula 1 - 4 ]$$

$$iSWAP ( α ) = [ \begin{matrix}1 & 0 & 0 & 0 \\ 0 & cos απ & - i sin απ & 0 \\ 0 & - i sin απ & cos απ & 0 \\ 0 & 0 & 0 & 1\end{matrix} ] \qquad ( formula 1 - 4 )$$

### Advantage of the Invention

According to the one aspect of the present invention, gate operation of a target bit can be executed in terms of software in the quantum computer.

### BRIEF DESCRIPTION OF THE DRAWINGS

FIG. 1 is a diagram illustrating one example of a decomposition circuit model with PSWAP gates regarding an arbitrary two-qubit gate.

FIG. 2 is a decomposition diagram with a unitary gate U_{d} having magic bases as an eigen vector regarding an arbitrary two-qubit gate.

FIG. 3 is a diagram illustrating one example of decomposition with PSWAP gates regarding the unitary gate U_{d} having the magic bases as the eigen vector.

FIG. 4(a) is a schematic diagram of a device structure of a quantum dot array; FIG. 4(b) is a diagram illustrating coupling between qubits with an array structure; and FIG. 4(c) is a diagram illustrating an index of column and row numbers and an interaction coefficient J.

FIG. 5A is a diagram illustrating qubits affected by a column PSWAP.

FIG. 5B is a diagram illustrating qubits affected by a row PSWAP.

FIG. 6 is a diagram illustrating a system configuration for carrying out the invention.

FIG. 7 is a diagram illustrating difference between a prior art (a) and the present invention (b).

FIG. 8(a) is a schematic diagram of the device structure of the quantum dot array; FIG. 8(b) is a schematic diagram of a part controlled by an exchange interaction control gate in the quantum dot array; FIG. 8(c) is a decomposition diagram of an arbitrary two-qubit gate with four column or row PSWAPs regarding which a constraint condition is given to rotation angles; and FIG. 8(d) is a diagram illustrating the four column or row PSWAPs that become an equivalent circuit to an identity operator due to the constraint condition.

FIG. 9A is a diagram illustrating a general format of decomposition with four PSWAP gates given the constraint condition regarding the unitary gate U_{d} having the magic bases as the eigen vector.

FIG. 9B is a diagram illustrating a general format of decomposition with four PSWAP gates given the constraint condition regarding the unitary gate U_{d} having the magic bases as the eigen vector.

FIG. 10 is a diagram illustrating rotation angle parameters when an arbitrary two-qubit gate is decomposed with Rx, Ry, and four PSWAP gates given the constraint condition.

FIG. 11 is a decomposition diagram of a CZ gate with four column or row PSWAPs given the constraint condition.

FIG. 12(a) is a decomposition diagram of a Control Unitary gate with CNOT gates and single-qubit gates; FIG. 12(b) is a decomposition diagram of the CZ gate with two PSWAP gates; and FIG. 12(c) is a decomposition diagram of the Control Unitary gate with four column or row PSWAPS given the constraint condition.

FIG. 13 is a decomposition diagram of a PSWAP gate with four column or row PSWAPs given the constraint condition.

FIG. 14 is a diagram illustrating embedding of a quantum Fourier transform circuit into a lattice array: (a) is a quantum Fourier transform circuit diagram with four qubits; (b) is a diagram illustrating a lattice-like four-qubit system; (c) is a diagram in which the quantum Fourier transform circuit is embedded into the lattice-like four-qubit system and is a quantum Fourier transform circuit equivalent to (a); and (d) illustrates a two-qubit gate in a circuit model of (c) and the use flow of the present invention.

### MODES FOR CARRYING OUT THE INVENTION

First, modes for carrying out the invention will be described.

As described above, qubits are disposed in an array manner and are given control lines common in units of column or row, exchange interaction between two qubits is controlled by this control line, and a two-qubit gate is obtained. Because the control lines are shared, the two-qubit gate is implemented for all qubit pairs in the same column or the same row, and this two-qubit gate on the plurality of qubits serves as the basic gate.

The exchange interaction Hamiltonian between a qubit on the l-th column and the m-th row and a qubit on the l+1-th column and the m-th row can be given as (formula 2-1).

$$[ Formula 2 - 1 ]$$

$${J}_{\{ l , m \} , h} ( {σ}_{x}^{\{ l , m \}} ⊗ {σ}_{x}^{\{ l , m + 1 \}} + {σ}_{y}^{\{ l , m \}} + {σ}_{y}^{\{ l , m + 1 \}} + {σ}_{z}^{\{ l , m \}} ⊗ {σ}_{z}^{\{ l , m + 1 \}} ) \qquad ( formula 2 - 1 )$$

Matrix representations of σₓ, σ_{y}, and σ_{z} at this time are each given by (formula 2-2).

$$[ Formula 2 - 2 ]$$

$${σ}_{x} = [ \begin{matrix}0 & 1 \\ 1 & 0\end{matrix} ] , \qquad ( formula 2 - 2 )$$

$${σ}_{y} = [ \begin{matrix}0 & - i \\ - i & 0\end{matrix} ] ,$$

$${σ}_{x} = [ \begin{matrix}1 & 0 \\ 0 & - i\end{matrix} ] ,$$

$$I = [ \begin{matrix}1 & 0 \\ 0 & 1\end{matrix} ]$$

Furthermore, suppose that {l, m} on the shoulder of σ indicates operation on the qubit on the l-th column and the m-th row.

It can be expected that the shapes of the quantum dots become uniform in the plane due to evenness of the semiconductor process, and it is predicted that parameters that characterize the individual qubits become even. Thus, it can be expected that the values of the exchange interaction coefficients are a constant value in the row or column. Therefore, it can be supposed that all exchange interaction coefficients are equal as in (formula 3).

$$[ Formula 3 ]$$

$${J}_{\{ l , m \} , h} = {J}_{\{ l , m \} , v} = J for ∀ l , ∀ m \qquad ( formula 3 )$$

Due to the sharing of the control line, exchange interaction acts on all of the qubits existing in the l-th column and the qubits existing in the l+1-th column, and a PSWAP gate is caused to operate on all qubits in the same column. This basic gate will be referred to as the column PSWAP. Similarly, a PSWAP gate in units of row caused to operate on all qubit pairs existing in the m-th row and the m+1-th row will be referred to as the row PSWAP.

Local selectivity can be obtained about the single-qubit gate by unevenly applying a magnetic field in such a manner that a microwave resonant frequency is different for each qubit, and it is possible to cause the desired single-qubit gate to operate on the desired one qubit.

In theoretical computer science, a quantum device having measurement operation to convert quantum data to classical information and quantum gates that are arbitrary 2N-dimensional unitary can be treated as a universal quantum computer. Implementing this universal quantum computer is necessary for implementation of quantum computing.

A method for implementing a 2N-dimensional arbitrary unitary operator will be described. It is known that the 2N-dimensional arbitrary unitary operator can be decomposed into the product of the single-qubit gates and the two-qubit gates. A single-qubit gate is given with a two-dimensional unitary operator, and a two-qubit gate is given with a four-dimensional unitary operator. Thus, to implement the quantum computer, it suffices to make the single-qubit gates and the two-qubit gates that allow creation of an arbitrary unitary operator of arbitrary 2N-dimensions.

In general, a quantum computer hardware device has physical characteristics specific to the device, and the single-qubit gates and the two-qubit gates that are easy to make differ for each device due to the characteristics. The quantum gate can be settled from the Hamiltonian that defines the energy structure of the device. At this time, the quantum gate that can be directly made without combining a plurality of quantum gates is referred to as the Hamiltonian-native operator. If an arbitrary unitary operator of arbitrary 2N-dimensions can be made by a combination of the Hamiltonian-native operators, the universal quantum computer is implemented.

A quantum device in which control lines are individually given to all quantum gates and a local two-qubit gate can be implemented is assumed. It is known that, particularly regarding a quantum device in which a PSWAP gate that is a two-qubit gate by exchange interaction is the Hamiltonian-native operation, an arbitrary two-qubit gate can be decomposed as in (formula 4) from Non-Patent Document 1 (H. Fan, V. Roychowdhury, and T. Szkopek, Phys. Rev. A72, 052323 (2005)).

$$[ Formula 4 ]$$

$$U = ( {V}_{A} ⊗ {V}_{B} ) ( {σ}_{z} ⊗ {σ}_{x} ) PSWAP ( γ ) ( {σ}_{z} ⊗ I ) PSWAP ( β ) * ( I ⊗ {σ}_{x} ) PSWAP ( α ) ( {U}_{A} ⊗ {U}_{B} ) \qquad ( formula 4 )$$

A method for specifically computing single-qubit gates V_{A}, V_{B}, U_{A}, and U_{B} is known from Non-Patent Document 2 (B. Kraus and J. I. Cirac, Phys. Rev. A63, 062309 (2000)). An arbitrary two-qubit gate U is decomposed into V′_{A}, V′_{B}, U′_{A}, and U′_{B} with use of U_{d} as in (formula 5-1) in Non-Patent Document 2, and a method for specifically obtaining V′_{A}, V′_{B}, U′_{A}, and U′_{B} is known.

$$[ Formula 5 - 1 ]$$

$$U = ( {V}_{A}^{′} ⊗ {V}_{B}^{′} ) {U}_{d} ( {V}_{A}^{′} ⊗ {V}_{B}^{′} ) \qquad ( formula 5 - 1 )$$

At this time, U_{d} in (formula 5-1) can be represented by (formula 5-3) with use of magic bases given by (formula 5-2).

$$[ Formula 5 - 2 ]$$

$$\vert {ϕ}_{1} 〉 = 1 / {\sqrt{2} [ 1 , 0 , 0 , 1 ]}^{T} , \qquad ( formula 5 - 2 )$$

$$\vert {ϕ}_{2} 〉 = 1 / {\sqrt{2} [ - i , 0 , 0 , i ]}^{T} ,$$

$$\vert {ϕ}_{3} 〉 = 1 / {\sqrt{2} [ 0 , 1 , - 1 , 0 ]}^{T} ,$$

$$\vert {ϕ}_{4} 〉 = 1 / {\sqrt{2} [ 0 , - i , - i , 0 ]}^{T}$$

$$[ Formula 5 - 3 ]$$

$${U}_{d} = {\sum }_{i = 1}^{4} {e}^{- i {λ}_{k}} \vert {ϕ}_{k} 〉 〈 {ϕ}_{k} \vert \qquad ( formula 5 - 3 )$$

The magic bases are the eigen vectors of U_{d}, and e-ink is the eigen value. Note that λₖ is a real number. V′_{A}, V′_{B}, U′_{A}, and U′_{B} in (formula 4) can be specifically computed with use of the values of V′_{A}, V′_{B}, U′_{A}, and U′ B.

Meanwhile, the PSWAP gate is given by (formula 6) when the magic bases are used.

$$[ Formula 6 ]$$

$$PSWAP ( α ) = \vert {ϕ}_{1} 〉 〈 {ϕ}_{1} \vert + \vert {ϕ}_{2} 〉 〈 {ϕ}_{2} \vert + {e}^{- i απ} \vert {ϕ}_{3} 〉 〈 {ϕ}_{3} \vert + \vert {ϕ}_{4} 〉 〈 {ϕ}_{4} \vert \qquad ( formula 6 )$$

It is known that the magic bases interchange with each other by the Pauli operators as in (table 1). (Table 1) indicates transformation of the magic bases by the Pauli operators.

TABLE 1

| | | | Correspondence of | | | |
|---|---|---|---|---|---|---|
| | | | Transformed Bases | | | |
| Pauli Operator | | | \|Φ₁ [symbol] | \|Φ₂ [symbol] | \|Φ₃ [symbol] | \|Φ₄ [symbol] |
| I | ⊗ | σₓ | \|Φ₄ [symbol] | \|Φ₃ [symbol] | \|Φ₂ [symbol] | \|Φ₁ [symbol] |
| I | ⊗ | σ_{y} | \|Φ₃ [symbol] | \|Φ₄ [symbol] | \|Φ₁ [symbol] | \|Φ₂ [symbol] |
| I | ⊗ | σ_{z} | \|Φ₂ [symbol] | \|Φ₁ [symbol] | \|Φ₄ [symbol] | \|Φ₃ [symbol] |
| σₓ | ⊗ | σₓ | \|Φ₁ [symbol] | \|Φ₂ [symbol] | \|Φ₃ [symbol] | \|Φ₄ [symbol] |
| σₓ | ⊗ | σ_{y} | \|Φ₂ [symbol] | \|Φ₁ [symbol] | \|Φ₄ [symbol] | \|Φ₃ [symbol] |
| σₓ | ⊗ | σ_{z} | \|Φ₃ [symbol] | \|Φ₄ [symbol] | \|Φ₁ [symbol] | \|Φ₂ [symbol] |
| σ_{y} | ⊗ | σ_{y} | \|Φ₁ [symbol] | \|Φ₂ [symbol] | \|Φ₃ [symbol] | \|Φ₄ [symbol] |
| σ_{y} | ⊗ | σ_{z} | \|Φ₄ [symbol] | \|Φ₃ [symbol] | \|Φ₂ [symbol] | \|Φ₁ [symbol] |
| σ_{z} | ⊗ | σ_{z} | \|Φ₁ [symbol] | \|Φ₂ [symbol] | \|Φ₃ [symbol] | \|Φ₄ [symbol] |

Thus, U_{d} can be represented as the product of the PSWAP gates as in (formula 7) with use of the result of table 1, and the equivalence of (formula 4) can be proven.

$$\begin{matrix}{U}_{d} = ( {e}^{- i ( {λ}_{1} - {λ}_{1} )} \vert {ϕ}_{1} 〉 〈 {ϕ}_{1} \vert + {\sum }_{i = 2 , 3 , 4} \vert {ϕ}_{k} 〉 〈 {ϕ}_{k} \vert ) ( {e}^{- i ( {λ}_{2} - {λ}_{2} )} \vert {ϕ}_{2} 〉 〈 {ϕ}_{2} \vert + {\sum }_{i = 1 , 3 , 4} \vert {ϕ}_{k} 〉 〈 {ϕ}_{k} \vert ) Γ \cdot ( {e}^{- i ( {λ}_{3} - {λ}_{4} )} \vert {ϕ}_{3} 〉 〈 {ϕ}_{3} \vert + {\sum }_{i = 1 , 2 , 4} \vert {ϕ}_{k} 〉 〈 {ϕ}_{k} \vert ) \\ = ( {σ}_{z} ⊗ {σ}_{x} ) PSWAP ( \frac{{λ}_{1} - {λ}_{4}}{π} ) ( {σ}_{z} ⊗ I ) PSWAP ( \frac{{λ}_{2} - {λ}_{4}}{π} ) ( I ⊗ {σ}_{x} ) PSWAP ( \frac{{λ}_{3} - {λ}_{4}}{/ π} )\end{matrix} \qquad [ Formula 7 ]$$

In the present invention, a consideration is made about a system in which a gate that can be made by operation of a control line shared by a plurality of qubit pairs as a two-qubit gate serves as the basic gate. In particular, a problem in a system in which the basic two-qubit gate serves as a two-qubit gate on a plurality of qubit pairs like the column or row PSWAP is supposed.

In general quantum algorithms and conventional techniques, a local two-qubit gate on specific two qubits is obtained. In contrast, in the system supposed by the present invention, the two-qubit gate for a plurality of qubit pairs serves as the basic gate. Thus, a local two-qubit gate needs to be implemented by combining the two-qubit gates on a plurality of qubit pairs.

Operation on a plurality of qubit pairs is the basic gate. In the present invention, with use of such a two-qubit gate on a plurality of qubit pairs, the general quantum algorithm provides a method for implementing operation equivalent to the two-qubit gate on specific two qubits.

First, a solution will be illustrated about the case in which a quantum hardware system has exchange interaction and the column or row PSWAP is Hamiltonian-native. A change is made from the gate decomposition into three local PSWAP gates given by (formula 4) to decomposition into four column or row PSWAPs as in (formula 8-1). At this time, a global phase λₜ is defined as (formula 8-2), with n being an integer. In addition, rotation angles α, β, γ, and δ satisfy (formula 8-3).

$$[ Formula 8 - 1 ]$$

$$U = [ {U}_{2} ⊗ {V}_{2} ] PSWAP ( δ ) [ I ⊗ {σ}_{z} ] PSWAP ( γ ) [ I ⊗ {σ}_{x} ] \cdot PSWAP ( β ) [ I ⊗ {σ}_{z} ] PSWAP ( α ) [ {e}^{i {λ}_{t} / 4} {U}_{1} ⊗ {V}_{1} ] \qquad ( formula 8 - 1 )$$

$$[ Formula 8 - 2 ]$$

$${λ}_{total} = {{\sum }_{k = 1}}^{4} {λ}_{k} = 2 n π + {\overline{λ}}_{t} \qquad ( formula 8 - 2 )$$

$$[ Formula 8 - 3 ]$$

$$α + β + γ + δ = 2 n \qquad ( formula 8 - 3 )$$

Due to the condition of (formula 8-3), four PSWAP gates regarding which the rotation angles are α, β, γ, and δ are caused to operate on a non-subject qubit pair to which single-qubit operation is not given. Therefore, (formula 8-4) holds. As a result, the situation in which operation is not effectively executed on the non-subject qubit pair is implemented.

$$\begin{matrix}[ Formula 8 - 4 ] & \\ PSWAP ( δ ) PSWAP ( γ ) PSWAP ( β ) PSWAP ( α ) = PSWAP ( δ + γ + β + α ) = I & ( formula 8 - 4 )\end{matrix}$$

That (formula 8-1) and (formula 8-2) hold will be exhibited. It is known that an arbitrary two-qubit gate is equivalent to the product of single-qubit operation and U_{d} from (formula 4) given from <Non-Patent Document 2>. Thus, it suffices for U_{d} to exhibit that the circuit model indicated by decomposition of U_{d} satisfying (formula 8-3) with use of four column or row PSWAPs is an equivalent circuit. First, U_{d} is decomposed with the magic bases and is transformed as in (formula 9-1). Then, when the value of αₖ is defined as in (formula 9-2), (formula 9-3) is obtained. Thus, the sum of α₁, α₂, α₃, and α₄ becomes 2, and (formula 8-3) is exhibited. Accordingly, it can be exhibited that identity operation (formula 9-4) can be implemented.

$$\begin{matrix}[ Formula 9 - 1 ] & \\ \begin{matrix}{U}_{d} = {{\sum }_{k = 1}}^{4} {e}^{- i {λ}_{k}} \vert {Φ}_{k} 〉 〈 {Φ}_{k} \vert \\ = {e}^{- i {λ}_{t} / 4} {{\sum }_{k = 1}}^{4} {e}^{- i ( {λ}_{t} - {\overline{λ}}_{t} / 4 )} \vert {Φ}_{k} 〉 〈 {Φ}_{k} \vert \\ = {e}^{- i {\overline{λ}}_{t} / 4} ( {e}^{- i ( {λ}_{1} - {\overline{λ}}_{t} / 4 )} \vert {Φ}_{1} 〉 〈 {Φ}_{1} \vert + {\sum }_{i \neq 1} \vert {Φ}_{k} 〉 〈 {Φ}_{k} \vert ) \\ ( {e}^{- i ( {λ}_{2} - {\overline{λ}}_{t} / 4 )} \vert {Φ}_{2} 〉 〈 {Φ}_{2} \vert + {\sum }_{i \neq 2} \vert {Φ}_{k} 〉 〈 {Φ}_{k} \vert ) \\ ( {e}^{- i ( {λ}_{3} - {\overline{λ}}_{t} / 4 )} \vert {Φ}_{3} 〉 〈 {Φ}_{3} \vert + {\sum }_{i \neq 3} \vert {Φ}_{k} 〉 〈 {Φ}_{k} \vert ) \\ ( {e}^{- i ( {λ}_{4} - {\overline{λ}}_{t} / 4 )} \vert {Φ}_{4} 〉 〈 {Φ}_{4} \vert + {\sum }_{i \neq 4} \vert {Φ}_{k} 〉 〈 {Φ}_{k} \vert )\end{matrix} & ( formula 9 \text{-1} )\end{matrix}$$

$$\begin{matrix}[ Formula 9 - 2 ] & \\ {πα}_{k} = {λ}_{k} - 4 \cdot \frac{{\overline{λ}}_{t}}{4} & ( formula 9 - 2 )\end{matrix}$$

$$\begin{matrix}[ Formula 9 - 3 ] & \\ {{\sum }_{k = 1}}^{4} {πα}_{k} = {{\sum }_{k = 1}}^{4} {λ}_{k} - 4 \cdot \frac{{\overline{λ}}_{t}}{4} = {λ}_{total} - {\overline{λ}}_{t} = 2 n π & ( formula 9 - 3 )\end{matrix}$$

$$\begin{matrix}[ Formula 9 - 4 ] & \\ PSWAP ( {α}_{1} ) PSWAP ( {α}_{2} ) PSWAP ( {α}_{3} ) PSWAP ( {α}_{4} ) = PSWAP ( {{\sum }_{k = 1}}^{4} {α}_{k} ) = I ⊗ I & ( formula 9 - 4 )\end{matrix}$$

Moreover, (formula 9-1) can be transformed as in (formula 9-5). Therefore, it is exhibited that U_{d} is decomposed with four column or row PSWAPs, and (formula 8-1) is exhibited.

$$\begin{matrix}[ Formula 9 - 5 ] & \\ \begin{matrix}{U}_{d} = {e}^{- i {\overline{λ}}_{t} / 4} ( {e}^{- i {α}_{1} / π} \vert {Φ}_{1} 〉 〈 {Φ}_{1} \vert + {\sum }_{i \neq 1} \vert {Φ}_{k} 〉 〈 {Φ}_{k} \vert ) \\ ( {e}^{- i {α}_{2} / π} \vert {Φ}_{2} 〉 〈 {Φ}_{2} \vert + {\sum }_{i \neq 2} \vert {Φ}_{k} 〉 〈 {Φ}_{k} \vert ) \\ ( {e}^{- i {α}_{3} / π} \vert {Φ}_{3} 〉 〈 {Φ}_{3} \vert + {\sum }_{i \neq 3} \vert {Φ}_{k} 〉 〈 {Φ}_{k} \vert ) \\ ( {e}^{- i {α}_{4} / π} \vert {Φ}_{4} 〉 〈 {Φ}_{4} \vert + {\sum }_{i \neq 4} \vert {Φ}_{k} 〉 〈 {Φ}_{k} \vert ) \\ = {e}^{- i {\overline{λ}}_{t} / 4} [ ( I ⊗ {σ}_{x} {σ}_{z} ) PSWAP ( {α}_{1} ) ( I ⊗ {σ}_{x} {σ}_{z} ) ] \\ [ ( I ⊗ {σ}_{x} ) PSWAP ( {α}_{2} ) ( I ⊗ {σ}_{x} ) ] \cdot \\ PSWAP ( {α}_{3} ) [ ( I ⊗ {σ}_{z} ) PSWAP ( {α}_{4} ) ( I ⊗ {σ}_{z} ) ]\end{matrix} & ( formula 9 \text{-5} )\end{matrix}$$

In the formula transformation of (formula 9-1), a nature that the Clifford operators transform the magic basis to the magic basis is used. Table 2 compiles the Clifford operators that cause transformation with respect to exchange between two magic bases and the bases before and after the transformation.

TABLE 2

| | | | Correspondence of | | | | |
|---|---|---|---|---|---|---|---|
| Clifford | | | Transformed Bases | | | | |
| Operator | | | \|Φ₁ [symbol] | \|Φ₂ [symbol] | \|Φ₃ [symbol] | \|Φ₄ [symbol] | Exchange |
| \sqrt{σ_{z}} | ⊗ | \sqrt{σ_{z}} | \|Φ₂ [symbol] | \|Φ₁ [symbol] | \|Φ₃ [symbol] | \|Φ₄ [symbol] | \|Φ₁ ↔ \|Φ₂ |
| \sqrt{σ_{y}} | ⊗ | \sqrt{σ_{y}}^{†} | \|Φ₃ [symbol] | \|Φ₂ [symbol] | \|Φ₁ [symbol] | \|Φ₄ [symbol] | \|Φ₁ ↔ \|Φ₃ |
| \sqrt{σₓ} | ⊗ | \sqrt{σₓ} | \|Φ₄ [symbol] | \|Φ₂ [symbol] | \|Φ₃ [symbol] | \|Φ₁ [symbol] | \|Φ₁ ↔ \|Φ₄ |
| \sqrt{σₓ} | ⊗ | \sqrt{σₓ}^{†} | \|Φ₁ [symbol] | \|Φ₃ [symbol] | \|Φ₂ [symbol] | \|Φ₄ [symbol] | \|Φ₂ ↔ \|Φ₃ |
| \sqrt{σ_{y}} | ⊗ | \sqrt{σ_{y}} | \|Φ₁ [symbol] | \|Φ₄ [symbol] | \|Φ₃ [symbol] | \|Φ₂ [symbol] | \|Φ₂ ↔ \|Φ₄ |
| \sqrt{σ_{z}} | ⊗ | \sqrt{σ_{z}}^{†} | \|Φ₁ [symbol] | \|Φ₂ [symbol] | \|Φ₄ [symbol] | \|Φ₃ [symbol] | \|Φ₃ ↔ \|Φ₄ |

Note that √σₓ, √σ_{y}, and √σ_{z} satisfy (formula 10-1) and (formula 10-2) and t denotes an Hermitian conjugate operator. The Clifford operator is an operator that can transform the Pauli operator to the Pauli operator. When the Pauli operator is sandwiched by the Clifford operator and the Hermitian conjugate operator thereof and the product is taken, the Pauli operator can be transformed to the Pauli operator. By combining exchange between two magic bases indicated in (table 2), transformation from an arbitrary magic basis to the magic basis can be made.

$$\begin{matrix}[ Formula 10 - 1 ] & \\ \sqrt{{σ}_{x}} = \frac{1}{\sqrt{2}} [ \begin{matrix}1 & - i \\ - i & 1\end{matrix} ] , \\ \sqrt{{σ}_{y}} = \frac{1 + i}{2} [ \begin{matrix}1 & - 1 \\ 1 & 1\end{matrix} ] , \\ \sqrt{{σ}_{z}} = [ \begin{matrix}1 & 0 \\ 0 & i\end{matrix} ] & ( formula 10 - 1 )\end{matrix}$$

$$\begin{matrix}[ Formula 10 - 2 ] & \\ {\sqrt{{σ}_{x}}}^{2} = {σ}_{x} , {\sqrt{{σ}_{y}}}^{2} = {σ}_{y} , {\sqrt{{σ}_{z}}}^{2} = {σ}_{z} & ( formula 10 - 2 )\end{matrix}$$

As generators for the Clifford operator group, operators of (formula 11) are known besides the Pauli operators of (formula 2-2).

$$\begin{matrix}[ Formula 11 ] & \\ T = \frac{1}{\sqrt{2}} [ \begin{matrix}1 & i \\ 1 & - i\end{matrix} ] , H = \frac{1}{\sqrt{2}} [ \begin{matrix}1 & 1 \\ 1 & - 1\end{matrix} ] , \\ CNOT = [ \begin{matrix}1 & 0 & 0 & 0 \\ 0 & 1 & 0 & 0 \\ 0 & 0 & 0 & 1 \\ 0 & 0 & 1 & 0\end{matrix} ] , CZ = [ \begin{matrix}1 & 0 & 0 & 0 \\ 0 & 1 & 0 & 0 \\ 0 & 0 & 1 & 0 \\ 0 & 0 & 0 & - 1\end{matrix} ] , \\ MS = \frac{1}{\sqrt{2}} [ \begin{matrix}1 & 0 & 0 & i \\ 0 & 1 & i & 0 \\ 0 & i & 1 & 0 \\ i & 0 & 0 & 1\end{matrix} ] , G = [ \begin{matrix}1 & 0 & 0 & 0 \\ 0 & i & 0 & 0 \\ 0 & 0 & i & 0 \\ 0 & 0 & 0 & - 1\end{matrix} ] & ( formula 11 )\end{matrix}$$

(Table 3) is indicated as an example of transformation from the magic basis to the magic basis by the Clifford operators other than that in (table 2). (Table 3) indicates the other Clifford operators and a transformation example of the magic basis. Note that the CNOT gate does not transform the magic basis to the magic basis, and therefore, attention needs to be paid thereto.

TABLE 3

| | | | Correspondence of | | | |
|---|---|---|---|---|---|---|
| | | | Transformed Bases | | | |
| Clifford Operator | | | \|Φ₁ [symbol] | \|Φ₂ [symbol] | \|Φ₃ [symbol] | \|Φ₄ [symbol] |
| T | ⊗ | T | \|Φ₄ [symbol] | \|Φ₁ [symbol] | \|Φ₃ [symbol] | \|Φ₂ [symbol] |
| H | ⊗ | H | \|Φ₁ [symbol] | \|Φ₄ [symbol] | \|Φ₃ [symbol] | \|Φ₂ [symbol] |
| | CZ | | \|Φ₂ [symbol] | \|Φ₁ [symbol] | \|Φ₃ [symbol] | \|Φ₄ [symbol] |
| | MS | | \|Φ₁ [symbol] | \|Φ₂ [symbol] | \|Φ₃ [symbol] | \|Φ₄ [symbol] |
| | G | | \|Φ₁ [symbol] | \|Φ₂ [symbol] | \|Φ₃ [symbol] | \|Φ₄ [symbol] |

Finally, the transformation of (formula 8-1) and (formula 9-5) can be made by transformation from the magic basis to the magic basis by the Clifford operators like those indicated in (table 1), (table 2), and (table 3). Thus, (formula 8-1) can be generalized as (formula 12).

$$\begin{matrix}[ Formula 12 ] & \\ U = [ {U}_{2} ⊗ {V}_{2} ] PSWAP ( δ ) [ {C}_{5} ⊗ {C}_{6} ] PSWAP ( γ ) [ {C}_{3} ⊗ {C}_{4} ] PSWAP ( β ) [ {C}_{1} ⊗ {C}_{2} ] PSWAP ( α ) [ {e}^{- i {\overline{λ}}_{t} / 4} {U}_{1} ⊗ {V}_{1} ] & ( formula 12 )\end{matrix}$$

At this time, C₁, C₂, C₃, and C₄ are appropriate Clifford operators decided by reference to (table 1), (table 2), and (table 3).

According to the present invention, by use of operation on a plurality of qubit pairs, the general quantum algorithm provides a method for implementing operation equivalent to the local two-qubit gate on specific two qubits.

The present invention is used for a system having a quantum device with such a structure as to control a plurality of qubits by one control wiring line like the column or row PSWAP. In particular, the present invention is targeted at the following quantum device. Qubits are arranged in a lattice manner. The basic single-qubit gate that can operate on an arbitrary qubit is limited to Rx(θ), Ry(θ), or Rz(θ). The two-qubit gate operates on a pair of adjacent two qubits. The column or row PSWAP generated by an exchange interaction gate that simultaneously occurs in the whole of each row or each column is the Hamiltonian-native basic gate.

A system having the above-described quantum device has three sections: a host computer that implements processing of decomposing an algorithm into a basic circuit model based on basic operation of a Hamiltonian-native quantum device and processing of change to a control signal pulse sequence description for implementing the basic circuit model; a qubit control section that generates a control pulse; and a qubit array section in which qubits having interaction are arranged in an array manner and a plurality of qubits are simultaneously controlled by a control wiring line.

Next, a decomposition example of a general two-qubit gate will be described.

The two-qubit gate decomposition method of Non-Patent Document 1 will be described. The two-qubit gate of Si quantum dots is generated by exchange interaction. Thus, a local PSWAP gate caused to operate on a desired pair of two qubits is a Hamiltonian-native gate.

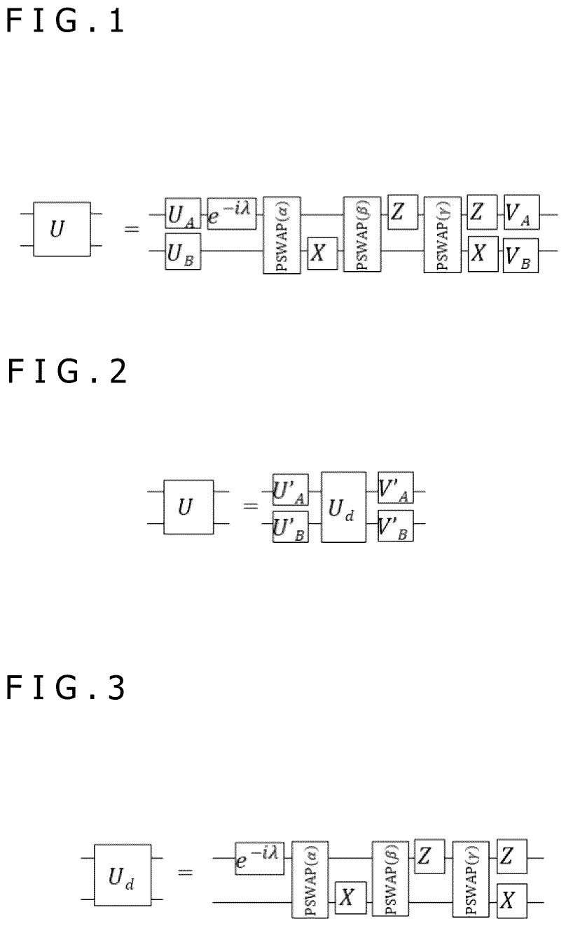

It is known that a universal quantum computer is configured through combining with single-qubit gates such as Rx, Ry, and Rz. At this time, as the method for decomposing the two-qubit gate, decomposition illustrated by (formula 4) or a circuit model like one in FIG. 1 is appropriate decomposition.

FIG. 1 indicates that an arbitrary two-qubit gate is equivalent to a circuit configured by a combinational circuit of three PSWAP gates and single-qubit gates.

The decomposition of FIG. 1 is indicated by using the fact that U_{d} given by FIG. 2 obtained as the result of Non-Patent Document 2 and (formula 5-3) can be decomposed as illustrated in FIG. 3.

FIG. 2 indicates that an arbitrary two-qubit gate can be decomposed into U_{d} and single-qubit gates. FIG. 3 indicates that U_{d} can be configured by the product of three PSWAP gates and single-qubit gates.

Embodiments of the present invention will be described below with use of drawings.

### First Embodiment

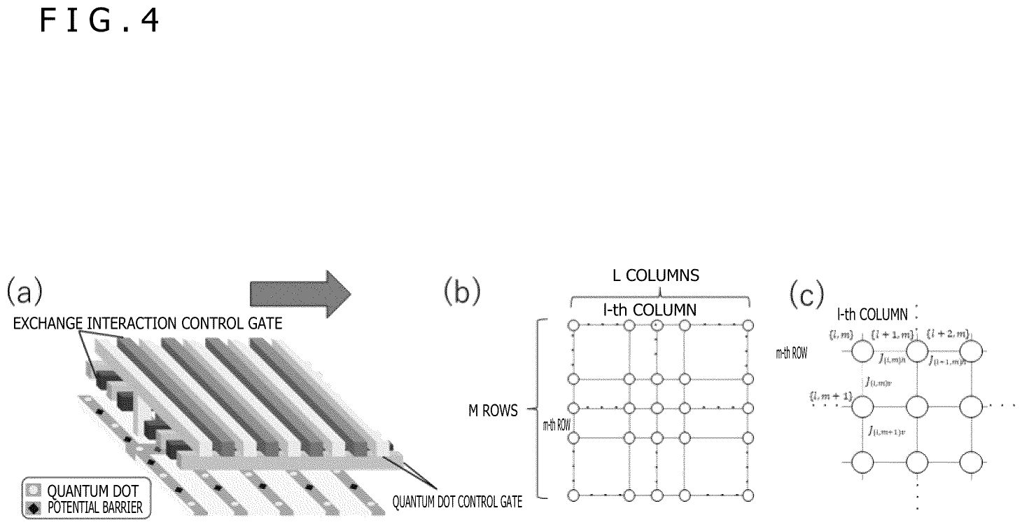

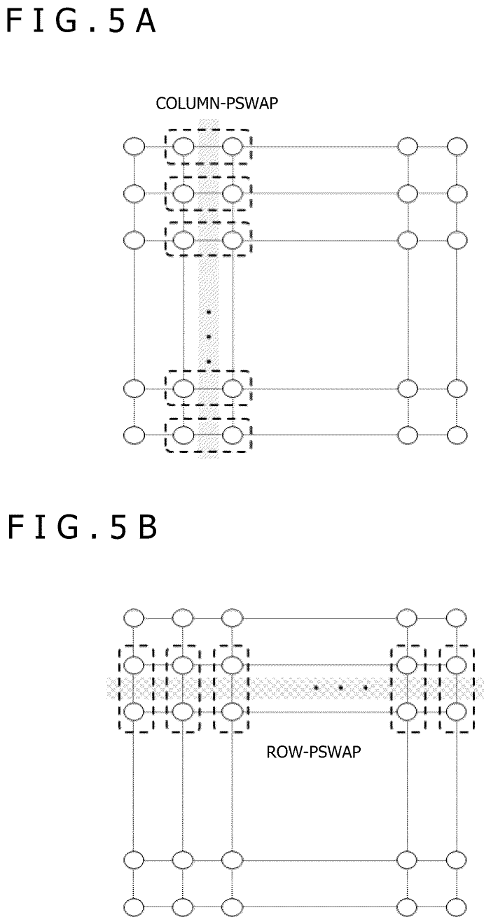

FIG. 4(a) illustrates a state of a quantum device in which quantum dots are disposed in an array manner. The quantum dots are formed in a two-dimensional square lattice manner, and interaction (potential barrier) between the quantum dots is formed. Furthermore, the quantum device has gate electrodes of a semiconductor (for example, poly-Si). There are two kinds of gate electrodes, quantum dot control gates and exchange interaction control gates.

The exchange interaction control gates and the quantum dot control gates are alternately disposed in two layers directly above a substrate. The exchange interaction control gates are used for control of two-qubit gate operation, and the quantum dot control gates are used for control of single-qubit gate operation. FIGS. 4(b) and 4(c) are diagrams that generalize and schematically illustrate coupling between qubits when the quantum dots present in the lowermost layer in FIG. 4(a) are used as the qubits.

FIG. 4(b) illustrates a state of the configuration of the qubit array and a state of the qubits disposed on M rows and L columns.

White circles indicate the positions of the qubits, and solid lines indicate coupling between the qubits.

In FIG. 4(c), indexes between qubits with coupling are illustrated. The bit on the m-th row and the 1-th column is indicated by {l, m}. The exchange interaction coefficient between the qubits {l, m} and {l+1, m} is defined as J_{{l, m},h}. The exchange interaction coefficient between the qubits {l, m} and {l, m+1} is defined as J_{{l, m}, v}.

FIGS. 5A and 5B illustrate the basic two-qubit gate at this time.

FIG. 5A illustrates a state of the column PSWAP. Each white circle indicates the quantum dot, and solid lines indicate coupling between the qubits. A hatching part means a wiring line to which exchange interaction is applied. In dotted rectangles, the exchange interaction simultaneously acts on all qubit pairs due to the wiring line of the hatching part, and the PSWAP gate is applied to all qubit pairs. FIG. B5 is obtained by interchanging the vertical and horizontal directions of FIG. 5A, and this diagram illustrates the row PSWAP.

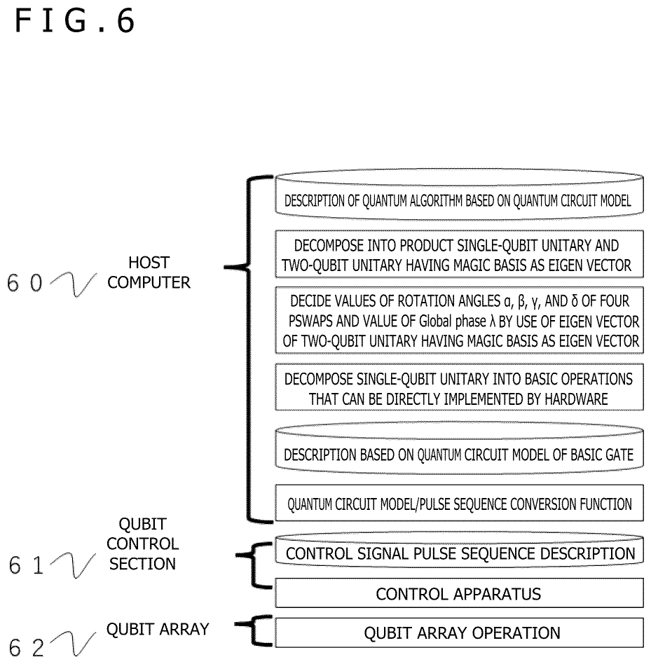

The configuration of the overall quantum computing system for causing the qubit array having characteristics of FIGS. 4, 5A, and 5B to work is illustrated in FIG. 6.

As illustrated in FIG. 6, the quantum computing system has a qubit array 62 for executing quantum computing, a qubit control section 61 for controlling the qubits, and a host computer 60 that prepares a command for quantum computing for the qubit control section 61.

The description of a quantum algorithm based on a circuit model using an arbitrary quantum gate is converted to a description based on a circuit model of the basic gate by use of a technique of the present invention. This description based on the circuit model of the basic gate is further converted to a control signal pulse sequence description. Then, the control signal pulse sequence description is transmitted to the qubit control section. This enables control of the qubits, and the qubit array works.

Examples of a physical system having the exchange interaction as above include a nuclear spin, an electron spin, a quantum dot, and an NMR qubit. Moreover, a device having an XY gate as the two-qubit gate, for example, a superconducting flux qubit such as a transmon qubit, can also be used.

Specifically, the host computer 60 executes description of a quantum algorithm based on a circuit model. Next, the host computer 60 executes decomposition into the product of a single-qubit unitary and a two-qubit unitary having a magic basis as an eigen value. Next, the host computer 60 decides the values of the rotation angles α, β, γ, and δ of four PSWAP gates and the value of Global phase λ by use of the eigen value of the two-qubit unitary having the magic basis as the eigen value. Next, the host computer 60 decomposes the single-qubit unitary into basic operations that can be directly implemented by hardware. Next, the host computer 60 executes description based on a circuit model of the basic gate. Finally, the host computer 60 executes a circuit model/pulse sequence conversion function.

The qubit control section 61 executes control signal pulse sequence description, and a control apparatus controls the qubit array 62 on the basis of the control signal pulse sequence. Then, the qubit array 62 causes the qubit array 62 to work.

Here, the host computer 60 is configured by a general operation apparatus that executes general operation. The qubit control section 61 and the qubit array 62 are configured by a quantum operation apparatus that specializes in quantum-mechanical operation.

The above-described configuration may be formed as an integrated computer, or may be formed by another computer in which any portions of a main storage apparatus, a general operation apparatus, a control apparatus, an auxiliary storage apparatus, an input apparatus, and an output apparatus are connected by a network.

The general operation is executed by a procedure similar to that of a normal computer. Data is exchanged between the main storage apparatus and the general operation apparatus that is an operation section, and the operation is advanced through the repetition thereof. On that occasion, the control apparatus supervises the overall procedure. A program to be executed by the general operation apparatus is stored in the main storage apparatus that is a storage section. When the storage capacity is insufficient in the main storage apparatus, the auxiliary storage apparatus that is also the storage section is used. The input apparatus is used for input of data, a program, and the like, and the output apparatus is used for output of a result. The input apparatus includes also an interface for network connection besides a manual input apparatus like a keyboard. Furthermore, this interface also serves as the output apparatus.

The quantum operation is also executed by a similar procedure. Data is exchanged between the main storage apparatus that is the storage section and the quantum operation apparatus that is an operation section, and the operation is advanced through the repetition thereof. On that occasion, the control apparatus supervises the overall procedure. A program to be executed by the quantum operation apparatus is stored in the main storage apparatus that is the storage section.

The program is converted to codes used in the quantum operation apparatus by use of the general operation apparatus, and is stored in the main storage apparatus. This encoded program is sent from the main storage apparatus to the quantum operation apparatus, and the control apparatus sends a control signal to the quantum operation apparatus to execute operation in accordance with the encoded program. The execution result by the quantum operation apparatus is sent to the main storage apparatus, and is subjected to post-processing by the general operation apparatus according to need.

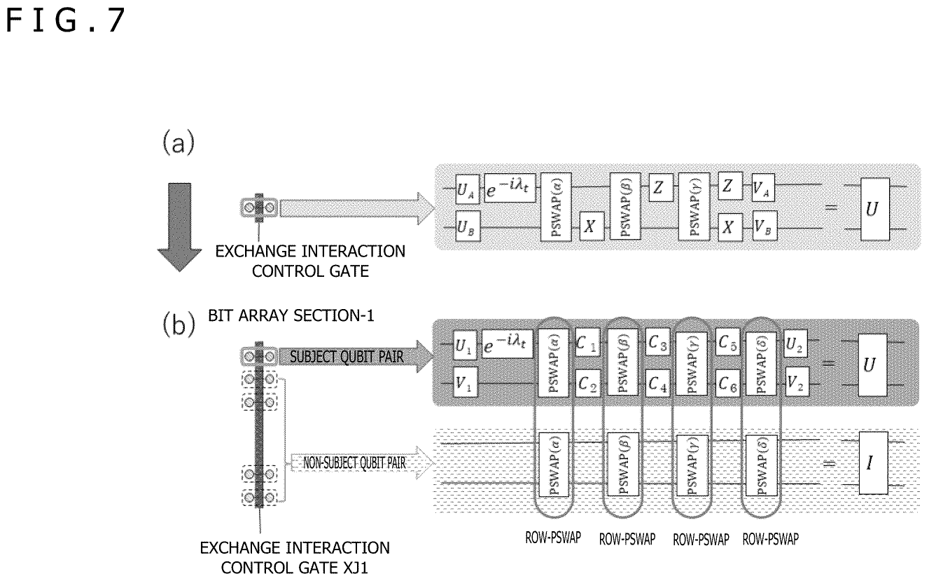

FIG. 7 is a diagram illustrating the difference between the present invention and a prior art (Non-Patent Document 1).

In the prior art, as in FIG. 7(a), gate decomposition regarding the system in which interaction between two qubits is controlled by one exchange interaction control gate is given. At this time, there is no condition regarding the sum of the rotation angles of the three PSWAP gates arising from the decomposition. Thus, it is impossible to apply the technique of the prior art to the system illustrated in FIG. 7(b), in which interaction between a plurality of qubit pairs is implemented by one exchange interaction gate wiring line.

The column or row PSWAPs are set to four, and a constraint condition like that of (formula 8-3) is given as in FIG. 7(b), which is an important characteristic of the present invention.

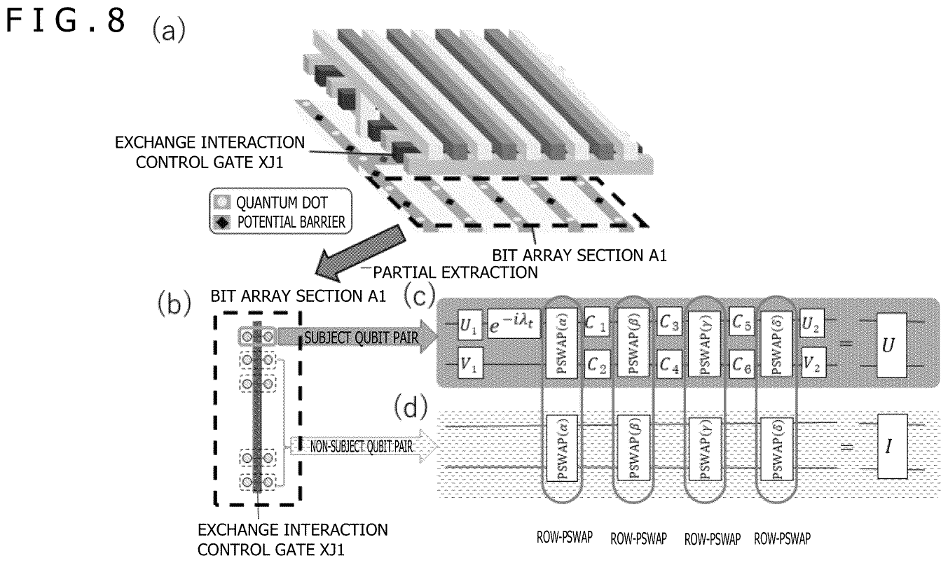

Next, with reference to FIG. 8, description will be made about a method for configuring an arbitrary two-qubit gate with use of the column and row PSWAPs, proposed by the present invention.

FIG. 8(a) is a schematic diagram of the device structure of the quantum dot array. FIG. 8(b) is a schematic diagram of the part controlled by the exchange interaction control gate in the quantum dot array. FIG. 8(c) is a decomposition diagram of an arbitrary two-qubit gate with four column or row PSWAPs regarding which a constraint condition is given to the rotation angles. FIG. 8(d) illustrates the four column or row PSWAPs that become an equivalent circuit to an identity operator due to the constraint condition.

In FIG. 8(b), all qubit pairs existing on the same column on which the column PSWAPs act (rectangles surrounding white circles in the array at the left part) are illustrated. In FIG. 8(c), a circuit model in the qubit pair on which the two-qubit gate is desired to operate is illustrated. In FIG. 8(d), a circuit model for the qubit pairs that are not treated as the operation subject is illustrated.

C₁, C₂, C₃, and C₄ in FIG. 8(c) are appropriate Clifford operators decided by reference to (table 1), (table 2), and (table 3). In FIG. 8(c), a desired two-qubit gate U is implemented by one qubit and four column PSWAPS.

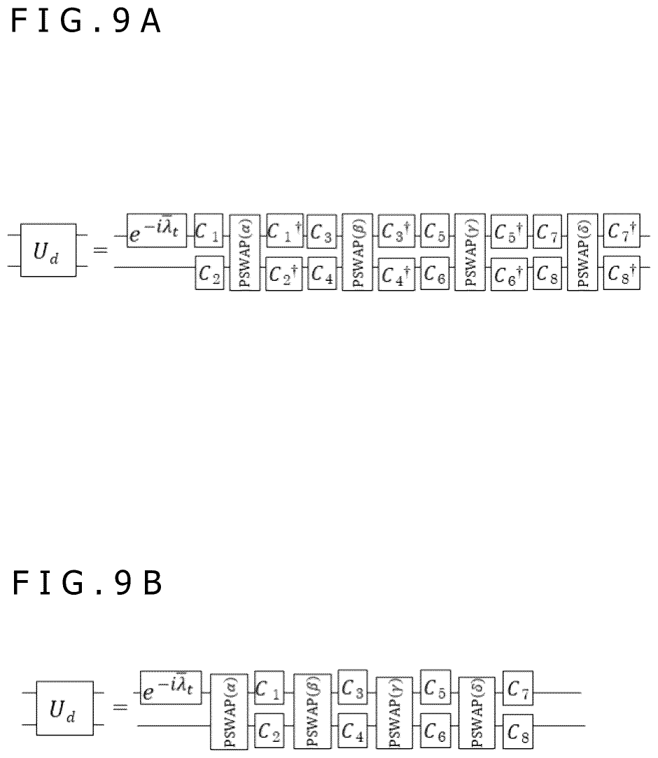

At this time, the two-qubit gate U is given by single-qubit gates and U_{d} satisfying (formula 5-3) as in FIG. 2 or (formula 5-1). Moreover, the arbitrary U_{d} is given by a circuit model like one in FIG. 9. Therefore, it is indicated that FIG. 8(c) is equivalent to the arbitrary two-qubit gate U.

On the other hand, regarding the qubit pairs that are not treated as the gate operation subject, the PSWAP gates with the rotation angles α, β, γ, and δ are caused to operate on the qubit pair of FIG. 8(d). At this time, α, β, γ, and δ satisfying (formula 8-3) are present, and (formula 8-4) holds. Therefore, this operation is equivalent to a result obtained in a case in which a gate of the identity operator is caused to operate on these qubit pairs, and the influence of the column PSWAPs can completely be canceled out.

As described above, the quantum computer of the present invention has the qubit array in which a plurality of qubits are disposed in a two-dimensional square lattice manner, the qubit control section that controls the qubit array, and the shared control lines that can control a plurality of qubit pairs composed of a pair of adjacent qubits.

The qubit control section is characterized in that it controls part of the qubit pairs among the plurality of qubit pairs by a plurality of two-qubit gates that are given a constraint condition relating to the product of operations and execute operation processing on a plurality of qubit pairs and does not control the qubit pairs other than the part of the qubit pairs.

Here, the shared control lines are the interaction control gates that control interaction between qubits of the qubit pair. The qubit array has the qubit control gates that control a plurality of qubits.

Furthermore, the qubit control section decomposes a plurality of two-qubit gates into four two-qubit gates, and controls the part of the qubit pairs by using the four two-qubit gates.

Moreover, the qubit control section combines the four two-qubit gates regarding which the sum of the rotation angles is an integer multiple of 2 with a plurality of single-qubit gates, and causes the two-qubit gate to act on the part of the qubit pairs among the plurality of qubit pairs, and cancels out action of the two-qubit gate for the qubit pairs other than the part of the qubit pairs.

Here, interaction operated by the shared control line is exchange interaction or XY interaction. The quantum computer is configured by a system in which operation on a plurality of qubit pairs as the basic gate is the PSWAP gate or the (iSWAP)^{α} gate. The PSWAP gate is a gate given as a power of a SWAP gate (formula 1-1) and satisfies (formula 1-2). Moreover, a matrix representation of the PSWAP gate is given by (formula 1-3), and a matrix representation of the (iSWAP)^{α} gate is given by (formula 1-4), and the rotation angle α takes a real value of 0 to 2.

Furthermore, the qubit control section configures the four two-qubit gates by four PSWAP gates regarding which the constraint condition is given to the rotation angles, and controls the part of the qubit pairs among the plurality of qubit pairs. For the qubit pairs other than the part of the qubit pairs, the qubit control section configures a circuit equivalent to an identity operator on the basis of the constraint condition to keep the qubit pairs other than the part of the qubit pairs from being affected by the PSWAP gate. Here, the qubit control section gives the constraint condition in such a manner that the product of the four PSWAP gates becomes the identity operator.

Next, an example in which a randomly generated two-qubit gate is specifically decomposed with use of the present invention will be illustrated. An arbitrary two-qubit gate can be decomposed like a circuit model of (formula 13) or FIG. 9A or 9B.

$$\begin{matrix}[ Formula 13 ] & \\ U = [ {R}_{y} ( {θ}_{3 , 3} ) {R}_{x} ( {θ}_{3 , 2} ) {R}_{y} ( {θ}_{3 , 1} ) {e}^{- i {λ}_{3}} ] ⊗ [ {R}_{y} ( {θ}_{4 , 3} ) {R}_{x} ( {θ}_{4 , 2} ) {R}_{y} ( {θ}_{4 , 1} ) {e}^{- i {λ}_{4}} ] PSWAP ( δ ) ( I ⊗ Z ) PSWAP ( γ ) ( I ⊗ X ) PSWAP ( β ) ( I ⊗ Z ) PSWAP ( α ) {e}^{- i {λ}_{5}} [ {R}_{y} ( {θ}_{1 , 3} ) {R}_{x} ( {θ}_{1 , 2} ) {R}_{y} ( {θ}_{1 , 1} ) {e}^{- i {λ}_{1}} ] ⊗ [ {R}_{y} ( {θ}_{2 , 3} ) {R}_{x} ( {θ}_{2 , 2} ) {R}_{y} ( {θ}_{2 , 1} ) {e}^{- i {λ}_{2}} ] & ( formula 13 )\end{matrix}$$

At this time, θ_{1,1}, θ_{1,2}, θ_{1,3}, θ_{2,1}, θ_{2,2}, θ_{2,3}, θ_{3,1}, θ_{3,2}, θ_{3,3}, θ_{4,1}, θ_{4,2}, θ_{4,3}, λ₁, λ₂, λ₃, λ₄, λ₅, α, β, γ, and δ are real number parameters. When U is given as [[0.6401+0.0333i, −0.0221+0.1191i, 0.6881+0.2419i, 0.14−0.2237i] [0.0085+0.0104i, 0.1448−0.6695i, −0.1505−0.0397i, 0.3323−0.6293i] [−0.2056−0.7315i, −0.0049−0.0445i, 0.0053+0.6303i, 0.1387+0.0636i] [0.0397−0.1004i, −0.7093−0.1046i, 0.0268−0.2699i, 0.5763+0.2619i]], the respective parameters are as follows: λ₁=0, θ_{1,1}=6.1796, θ_{1,2}=0.9444, θ_{1,3}=0, λ₂=0, θ_{2,1}=0.8747, θ_{2,2}=1.6662, θ_{2,3}=3.1416, λ₃=0, θ_{3,1}=3.3518, θ_{3,2}=1.6137, θ_{3,3}=−1.5708, λ₄=0, θ_{4,1}=6.7167, θ_{4,2}=2.1937, θ_{4,3}=−1.5708, α=−0.0065, β=−0.0067, γ=0.0699, and δ=0.1666.

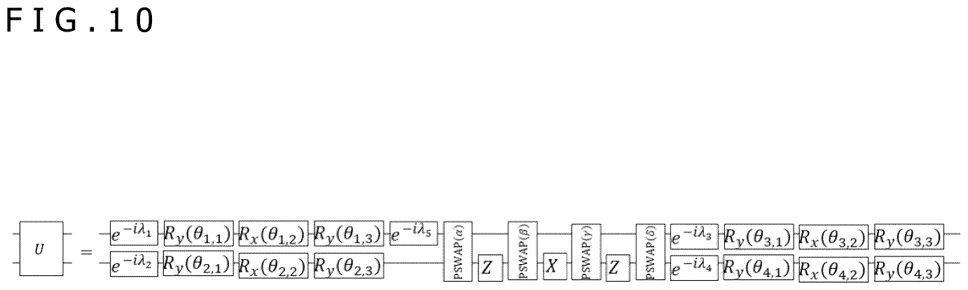

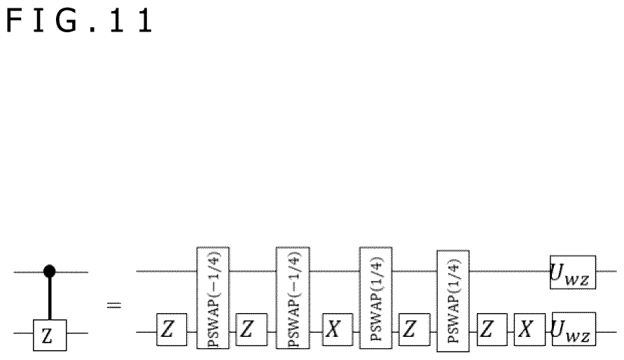

FIG. 10 illustrates rotation angle parameters when an arbitrary two-qubit gate is decomposed with Rx, Ry, and four PSWAPs given a constraint condition.

### Second Embodiment

In a second embodiment, decomposition examples of the two-qubit gate that frequently appears will be illustrated. First, a method for decomposing the CZ gate with four PSWAPs will be presented. The CZ gate is represented by (formula 14-1) with use of the magic bases and single-qubit gates Uwz.

$$\begin{matrix}[ Formula 14 - 1 ] & \\ CZ = ( {U}_{wz} ⊗ {U}_{wz} ) ( - i \vert {ϕ}_{1} 〉 〈 {ϕ}_{1} \vert - i \vert {ϕ}_{2} 〉 〈 {ϕ}_{2} \vert + i \vert {ϕ}_{3} 〉 〈 {ϕ}_{3} \vert + i \vert {ϕ}_{4} 〉 〈 {ϕ}_{4} \vert ) & ( formula 14 - 1 )\end{matrix}$$

Note that the CZ gate satisfying (formula 14-2) can be represented by the product of PSWAP gates like a circuit model indicated by (formula 14-3) or FIG. 11 by use of four √SWAP gates. At this time, a similar result can be obtained also when the Pauli operators in (formula 11-3) and FIG. 11 are changed to other Clifford operators by reference to the transformation between the magic bases in (table 1), (table 2), and (table 3).

$$\begin{matrix}[ Formula 14 - 2 ] & \\ {U}_{wz} = \frac{1}{\sqrt{2}} ( I + i {σ}_{z} ) & ( formula 14 - 2 )\end{matrix}$$

$$\begin{matrix}[ Formula 14 - 3 ] & \\ \begin{matrix}CZ = ( {U}_{wz} ⊗ {U}_{wz} ) ( {e}^{- i π / 2} \vert {ϕ}_{1} 〉 〈 {ϕ}_{1} \vert + \\ {e}^{- i π / 2} \vert {ϕ}_{2} 〉 〈 {ϕ}_{2} \vert + \vert {ϕ}_{3} 〉 〈 {ϕ}_{3} \vert + \vert {ϕ}_{4} 〉 〈 {ϕ}_{4} \vert ) \\ = {e}^{- \frac{1}{2} π} ( {U}_{wz} ⊗ {U}_{wz} ) ( I ⊗ {σ}_{x} {σ}_{z} ) PSWAP ( 1 / 4 ) \\ ( I ⊗ {σ}_{z} ) PSWAP ( 1 / 4 ) ( I ⊗ {σ}_{x} ) PSWAP ( - 1 / 4 ) \\ ( I ⊗ {σ}_{z} ) PSWAP ( - 1 / 4 ) ( I ⊗ {σ}_{z} )\end{matrix} & ( formula 14 - 3 )\end{matrix}$$

The CNOT gate is represented as the product of the CZ gate and the Hadamard gate H (formula 15-1). Thus, the CNOT gate can be represented by the product of PSWAP gates as (formula 15-2). At this time, a similar result can be obtained also when the Pauli operators in (formula 12-3) are changed to other Clifford operators by reference to the transformation between the magic bases in (table 1), (table 2), and (table 3).

$$\begin{matrix}[ Formula 15 - 1 ] & \\ CNOT = ( I ⊗ H ) CZ ( I ⊗ H ) & ( formula 15 - 1 )\end{matrix}$$

$$\begin{matrix}[ Formula 15 - 2 ] & \\ CNOT = {e}^{- \frac{1}{2} π} ( {U}_{wz} ⊗ {HU}_{wz} {σ}_{x} {σ}_{z} ) PSWAP ( 1 / 4 ) ( I ⊗ {σ}_{z} ) PSWAP ( 1 / 4 ) ( I ⊗ {σ}_{x} ) \cdot PSWAP ( - 1 / 4 ) ( I ⊗ {σ}_{z} ) PSWAP ( - 1 / 4 ) ( I ⊗ {σ}_{z} H ) & ( formula 15 - 2 )\end{matrix}$$

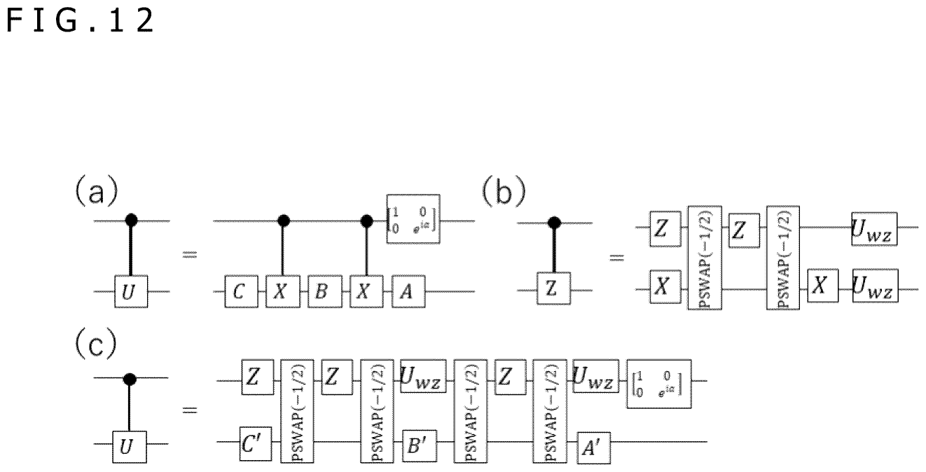

Next, the control gate will be described. In general, it is known that the Control Unitary gate is decomposed with two CNOT gates and single-qubit gates like a circuit model indicated by (formula 16-1) or FIG. 12(a) (Non-Patent Document 1).

$$\begin{matrix}[ Formula 16 - 1 ] & \\ Control - U = ( I ⊗ A ) CNOT ( I ⊗ B ) CNOT ( I ⊗ C ) where U = {e}^{i α} AXBXC , and ABC = I & ( formula 16 - 1 )\end{matrix}$$

The CNOT gate can be represented with use of two √SWAP gates like a circuit model indicated by (formula 16-2) or FIG. 11(b). Thus, the CNOT gate can be represented as in the diagram with use of two √SWAP gates.

$$\begin{matrix}[ Formula 16 - 2 ] & \\ CNOT = ( {U}_{wz} ⊗ {HU}_{wz} {σ}_{x} ) PSWAP ( - 1 / 2 ) ( {σ}_{z} ⊗ I ) PSWAP ( - 1 / 2 ) ( {σ}_{z} ⊗ {σ}_{x} ) & ( formula 16 - 2 )\end{matrix}$$

Thus, the Control Unitary gate can be represented by (formula 16-3) or FIG. 12(c) through combining four √SWAP gates. At this time, a similar result can be obtained also when the Pauli operators in (formula 13-1), (formula 13-3), and FIG. 12 are changed to other Clifford operators by reference to the transformation between the magic bases in (table 1), (table 2), and (table 3).

$$\begin{matrix}[ Formula 16 - 3 ] & \\ Control - U = ( {U}_{wz} {e}^{i α} ⊗ {A}^{′} ) PSWAP ( - 1 / 2 ) ( {σ}_{z} ⊗ I ) PSWAP ( - 1 / 2 ) ( {U}_{wz} ⊗ {B}^{′} ) PSWAP ( - 1 / 2 ) ( {σ}_{z} ⊗ I ) PSWAP ( - 1 / 2 ) ( Z ⊗ {C}^{′} ) & ( formula 16 - 3 )\end{matrix}$$

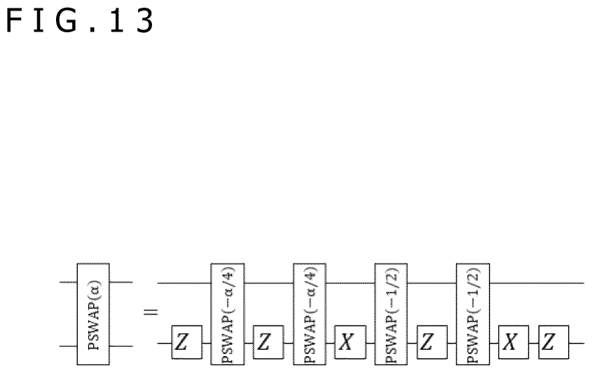

Finally, a method for decomposing the PSWAP gate with four PSWAP gates will be summarized. By decomposing the PSWAP gate into four PSWAP gates by the present invention, the column PSWAP can be caused to operate only on desired two qubits. The PSWAP gate can be decomposed as in (formula 17) or FIG. 13 by reference to (formula 6) and (formula 9-1). At this time, a similar result can be obtained also when the Pauli operators in (formula 14) and FIG. 13 are changed to other Clifford operators by reference to the transformation between the magic bases in (table 1), (table 2), and (table 3).

$$\begin{matrix}[ Formula 17 ] & \\ PSWAP ( α ) = {e}^{- i απ / 4} [ ( I ⊗ {σ}_{x} {σ}_{z} ) PSWAP ( - α / 4 ) ( I ⊗ {σ}_{x} {σ}_{z} ) ] [ ( I ⊗ {σ}_{z} ) PSWAP ( - α / 4 ) ( I ⊗ {σ}_{z} ) ] \cdot PSWAP ( α3 / 4 ) [ ( I ⊗ {σ}_{z} ) PSWAP ( - α / 4 ) ( I ⊗ {σ}_{z} ) ] & ( formula 17 )\end{matrix}$$

### Third Embodiment

In a third embodiment, embedding of a quantum Fourier transform circuit into a lattice array will be described.

The effectiveness of the present invention becomes apparent by specifically illustrating a method for embedding one example of a famous quantum algorithm into qubits arranged in a lattice manner.

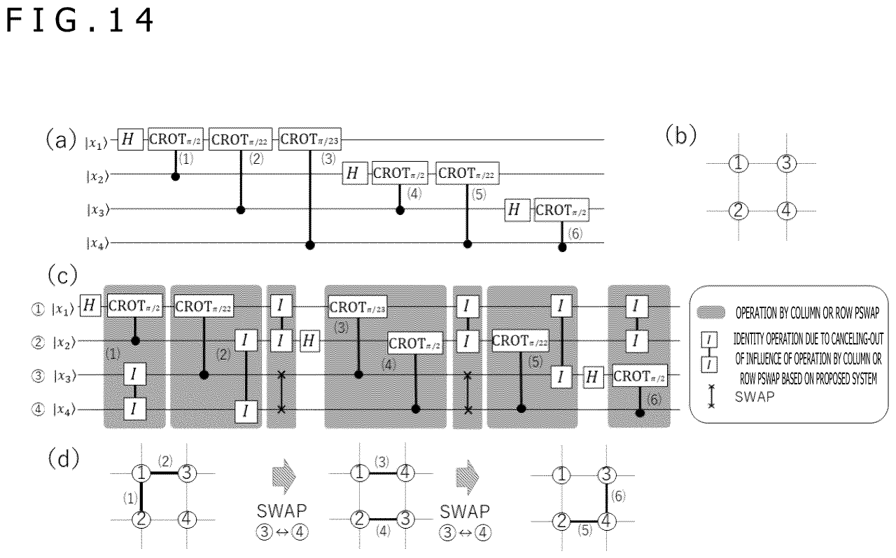

Here, as one example of the quantum algorithm, a quantum Fourier transform (QFT) with four qubits like one in FIG. 14(a) is illustrated as an example. It is an algorithm to solve the QFT, and is a highly versatile quantum algorithm utilized in a plurality of algorithms such as a phase estimation algorithm, a linear system solution by the Harrow, Hassidim and Lloyd method (HHL), and Shor's algorithm.

As the implementation form of the OFT, a quantum device in which quantum dots are disposed in an array manner, at which the present invention is targeted, like one in FIG. 14(b) will be treated as the subject, and embedding of the interest will be studied. Suppose that, at this time, a two-qubit gate is present only between adjacent two-qubit gates and the two-qubit gate is implemented by the exchange interaction Hamiltonian.

A control line of the two-qubit gate is disposed on each column, and the column or row PSWAP(θ) like that in FIG. 5A or 5B serves as the basic two-qubit gate. The value of θ indicates the rotation angle of the Hamiltonian, and is a value determined depending on the application time of the exchange interaction and the magnitude of the exchange interaction. The value of θ becomes larger when the application time is longer, and the value of θ becomes larger when the magnitude of the exchange interaction becomes larger.

It is on the assumption that, supposing that it can be expected that the shapes of the quantum dots become uniform in the plane due to evenness of the semiconductor process and that parameters that characterize the individual qubits become even, (formula 3) holds.

In the algorithm, basically the two-qubit gate is individually caused to operate on desired two qubits. Therefore, it is required to use the present invention in a quantum computer in which the column or row PSWAP(θ) serves as the basic two-qubit gate. Conversely, processing is enabled without using the present invention when two or more two-qubit gates are the “same gate” at the time of algorithm creation and two or more pairs of two qubits as the subject are present on the same column or row.

At this time, the condition for allowing the two-qubit gates to be the “same gate” is that the rotation angles θ of the PSWAP(θ) gates when the two-qubit gate is decomposed by (formula 8-1) are equal to each other. It is known that an arbitrary Control Unitary gate can be decomposed into two CNOT gates and three single-qubit gates. Moreover, the CNOT gate is decomposed into two PSWAP(1/2) gates.

Thus, even the Control Unitary gate in which the unitary caused to operate on the controlled bit differs depending on the state of the control bit can be regarded as the “same gate” in terms of the rotation angle of the PSWAP gate. Thus, in the case of the “same gate,” the single-qubit gate can take various gates, whereas the rotation angles of the PSWAP gates that are the two-qubit gates are equal to each other. On the other hand, the PSWAP(θ) gates are different from each other in the rotation angle θ in general, and therefore are not the “same gate.”

The Control Unitary gates can be regarded as the “same gate,” and therefore are capable of simultaneous execution as illustrated in FIG. 14(d). On the other hand, even with the SWAP gate, the proposed technique needs to be used as in the diagram when the SWAP gate does not operate on the whole of the column. Details of the SWAP gate decomposition method at this time have been described in the second embodiment.

Also in an algorithm other than the QFT, the Control Unitary gates are often the “same gate,” and therefore are capable of simultaneous execution in some cases. However, they are not the “same gate” in many cases when a general algorithm is executed. In particular, when the SWAP gate, the PSWAP gate, or the like is desired to locally operate on a desired qubit pair, the technique of the present invention needs to be used.

Here, an actual example of the QFT will be illustrated. In terms of executing a QFT circuit of FIG. 14(a) by using a qubit array with a lattice-like arrangement like one in FIG. 14(b), implementation is enabled with an equivalent circuit like one in FIG. 14(c). In FIG. 14(c), identity operations made with use of the technique of the present invention are clearly illustrated. (3) CROT(π/2³) gate and (4) CROT(π/2) gate of two-qubit operation can be regarded as the “same gate” because the rotation angles are equal to each other when they are decomposed into PSWAP gates.

FIG. 14(d) illustrates the operation procedure of the two-qubit gates (1) to (4) in FIGS. 14(a) and 14(c) with the arrangement diagram of the qubit array in FIG. 14(b). The proposed technique of the present invention is used in all of two-qubit gate operations other than (3) and (4).

Specifically, in FIG. 14(d), at first, the gates of (1) and (2) are each individually caused to operate with use of the proposed technique of the present invention. Next, the SWAP gate is executed with use of the proposed technique. Next, (3) and (4) are simultaneously caused to operate by the column PSWAP. The CROT gates can be treated as the “same gate.”

Next, the SWAP gate is executed with use of the proposed technique. Finally, the gates of (5) and (6) are each individually caused to operate with use of the proposed technique.

In the above-described embodiments, the operation method for implementing the two-qubit gate in the system in which a plurality of qubit pairs are operated by the shared control line is provided. In the operation method, the two-qubit gate is implemented by decomposing a desired arbitrary two-qubit gate into four or more two-qubit gates given the constraint condition relating to the product of operations.

The above-described operation method configures the computing processing system having three elements, the classical computer that describes a quantum algorithm as a circuit model based on the basic gate and thereafter converts this circuit model based on the basic gate as a pulse sequence of a control signal of the quantum computer, the signal section that generates the control signal, and the quantum operation apparatus that operates a plurality of qubit pairs by the shared control line.

The system is configured in which interaction operated by the shared control line is exchange interaction or XY interaction and operation on a plurality of qubit pairs as the basic gate is the PSWAP gate or the (iSWAP) a gate.

Note that the PSWAP gate is a gate given as a power of a SWAP gate (formula 1-1) and satisfies (formula 1-2). Moreover, a matrix representation of the PSWAP gate is given by (formula 1-3), and the rotation angle α takes a real value of 0 to 2. Furthermore, a matrix representation of the (iSWAP)^{α} gate is given by (formula 1-4), and the rotation angle α takes a real value of 0 to 2.

As above, the present invention provides a technique for implementing the desired gate on desired arbitrary two qubits in the system in which a plurality of qubit pairs are operated by the shared control line.

In the conventional quantum device, it is basic to implement one basic gate operation by one control line. However, when qubits are integrated and the scale is increased, a plurality of qubits need to be simultaneously implemented by one control line. In particular, in the system in which a plurality of qubit pairs are operated by the shared control line, the two-qubit gate as the basic gate is operation processing on a plurality of qubit pairs. In general, the quantum algorithm is described with use of operation on specific one pair of two-qubit gates. Therefore, in the system in which qubit pairs are operated by the shared control line, the specific one pair of two-qubit gates need to be executed with use of the two-qubit gate on a plurality of qubit pairs as the basic gate.

Thus, in the present invention, the two-qubit gates on a plurality of qubit pairs regarding which the sum of the rotation angles is an integer multiple of 2 and single-qubit gates are used in combination. Thereby, a desired two-qubit gate is implemented for desired one pair of two qubits. In addition, processing of canceling out the effect of the two-qubit gate on the qubit pairs other than the desired qubit pairs is executed.

According to the present invention, by using operation on a plurality of qubit pairs, the general quantum algorithm can provide a method for implementing operation equivalent to the local two-qubit gate on specific two qubits.

### DESCRIPTION OF REFERENCE NUMERALS

60: Host computer
61: Qubit control section
62: Qubit array

1. A quantum computer comprising:
a qubit array in which a plurality of qubits are disposed in a two-dimensional square lattice manner;
a qubit control section that controls the qubit array; and
a shared control line capable of controlling a plurality of qubit pairs composed of a pair of the qubits adjacent,
wherein the qubit control section controls part of the qubit pairs among the plurality of qubit pairs by a plurality of two-qubit gates that are given a constraint condition relating to a product of operations and that execute operation processing on a plurality of the qubit pairs, and does not control the qubit pairs other than the part of the qubit pairs.

2. The quantum computer according to claim 1,
wherein the shared control line is an interaction control gate that controls interaction between qubits of the qubit pair, and
the qubit array has a qubit control gate that controls a plurality of the qubits.

3. The quantum computer according to claim 1,
wherein the qubit control section
decomposes a plurality of the two-qubit gates into four, and
controls the part of the qubit pairs by use of the four two-qubit gates.

4. The quantum computer according to claim 3,
wherein the qubit control section combines the four two-qubit gates regarding which a sum of rotation angles is an integer multiple of 2 with a plurality of single-qubit gates, causes the two-qubit gate to act on the part of the qubit pairs among the plurality of qubit pairs, and cancels out action of the two-qubit gate for the qubit pairs other than the part of the qubit pairs.

5. The quantum computer according to claim 4,
wherein interaction operated by the shared control line is exchange interaction or XY interaction,
the quantum computer is configured by a system in which operation on a plurality of the qubit pairs as a basic gate is a PSWAP gate or an (iSWAP)^{α} gate,
the PSWAP gate is a gate given as a power of a SWAP gate (formula 1-1) and satisfies (formula 1-2), and
a matrix representation of the PSWAP gate is given by (formula 1-3), a matrix representation of the (iSWAP) a gate is given by (formula 1-4), and a rotation angle takes a real value of 0 to 2.
$$\begin{matrix}[ Formula 18 - 1 ] & \\ PSWAP ( α ) = {( SWAP )}^{α} & ( formula 1 - 1 )\end{matrix}$$
$$\begin{matrix}[ Formula 18 - 2 ] & \\ PSWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] & ( formula 1 - 2 )\end{matrix}$$
$$\begin{matrix}[ Formula 18 - 3 ] & \\ PSWAP ( α ) = [ \begin{matrix}1 & 0 & 0 & 0 \\ 0 & \frac{1 + {e}^{i απ}}{2} 0 & \frac{1 - {e}^{i απ}}{2} & 0 \\ 0 & \frac{1 - {e}^{i απ}}{2} 0 & \frac{1 + {e}^{i απ}}{2} & 0 \\ 0 & 0 & 0 & 1\end{matrix} ] & ( formula 1 - 3 )\end{matrix}$$
$$\begin{matrix}[ Formula 18 - 4 ] & \\ iSWAP ( α ) = [ \begin{matrix}1 & 0 & 0 & 0 \\ 0 & cos απ & - i sin απ & 0 \\ 0 & - i sin απ & cos απ & 0 \\ 0 & 0 & 0 & 1\end{matrix} ] & ( formula 1 - 4 )\end{matrix}$$

6. The quantum computer according to claim 5,
wherein the qubit control section
configures the four two-qubit gates by four PSWAP gates as the PSWAP gates regarding which the constraint condition is given to the rotation angles, and controls the part of the qubit pairs among the plurality of qubit pairs, and
for the qubit pairs other than the part of the qubit pairs, configures a circuit equivalent to an identity operator on a basis of the constraint condition to keep the qubit pairs other than the part of the qubit pairs from being affected by the PSWAP gate.

7. The quantum computer according to claim 6,
wherein the qubit control section gives the constraint condition in such a manner that a product of the four PSWAP gates becomes the identity operator.

8. A quantum computing system comprising:
the quantum computer according to claim 7; and
a host computer that gives a command for quantum computing to the qubit control section,
wherein the host computer
converts a quantum algorithm based on a circuit model using a quantum gate to a circuit model of a basic gate,
converts the circuit model of the basic gate to a control signal pulse sequence, and
sends the control signal pulse sequence to the qubit control section, and
the qubit control section controls the qubits and causes the qubit array to operate on a basis of the control signal pulse sequence.

9. The quantum computing system according to claim 8,
wherein the host computer converts the quantum algorithm to the circuit model of the basic gate by executing
processing of decomposition into a product of a single-qubit unitary and a two-qubit unitary having a magic basis as an eigen value,
processing of deciding values of the rotation angles of the four PSWAP gates by using the eigen value of the two-qubit unitary, and
processing of decomposing the single-qubit unitary into basic operations allowed to be directly implemented by hardware.

10. The quantum computing system according to claim 8,
wherein the host computer is configured by a general operation apparatus that executes general operation, and
the qubit control section is configured by a quantum operation apparatus that executes quantum-mechanical operation.
